(19) United States
(12) Patent Application Publication
(10) Pub. No.: US 2011/0151056 A1
(43) Pub. Date: Jun. 23, 2011

(54) Method of enzymatically degrading raw whole vegetables

(76) Inventor: Uchenna Chukwu, Minnetonka, MN (US)

(21) Appl. No.: 12/932,432

(22) Filed: Feb. 26, 2011

Related U.S. Application Data
(63) Continuation-in-part of application No. 11/986,609, filed on Nov. 23, 2007.
Application No. 11/986,609 is a continuation-in-part of application No. 10/619,403, filed on Jul. 14, 2003, now Pat. No. 7,407,678.
Application No. 10/619,403 is a continuation-in-part of application No. 09/495,960, filed on Feb. 2, 2000, now abandoned.
Application No. 09/495,960 is a continuation-in-part of application No. 09/196,844, filed on Nov. 20, 1998, now Pat. No. 6,033,692.

(51) Int. Cl. A23L 1/212

(52) U.S. Cl. 426/46; 426/52; 426/61

(57) ABSTRACT

A method of enzymatically degrading raw whole vegetables that includes providing a raw whole vegetable composition having a first outer layer to which a plurality of enzymes that includes carbohydrase, protease, and/or lipases is applied for a time that is sufficient to form an enzyme-degraded vegetable.

### CROSS-REFERENCE TO RELATED APPLICATION(S)

This application is a continuation-in-part of U.S. Serial application Ser. No. 11/986,609, filed on Nov. 23, 2007, which is a continuation in part of U.S. Serial application Ser. No. 10/619,403 filed Jul. 14, 2003, now U.S. Pat. No. 7,407,678, which is a continuation-in-part of application Ser. No. 09/495,960, filed Apr. 1, 2002, now abandoned, which is a continued prosecution application of application Ser. No. 09/495,960, filed Feb. 2, 2000, now abandoned, which is a continuation-in-part of application Ser. No. 09/196,844, filed on Nov. 20, 1998, now U.S. Pat. No. 6,033,692 all of which are incorporated herein in their entirety.

### BACKGROUND OF THE INVENTION

During the last several years, growing concern over chronic diseases, such as cancer, diabetes and heart disease have motivated consumers to seek foods for consumption that are effective in treating chronic diseases while promoting a healthier lifestyle.

Consumption of vegetables having phytochemicals may prove challenging to individuals as vegetables contain anti-nutritional components, such as allergenic soy or legume protein, indigestible sugars, enzyme inhibitors, nutrient-binding substances or toxic compounds. Traditional approaches used to eliminate anti-nutritional components include heat, pressure, solvent extraction and/or fermentation. These strategies may add to the costs while undesirably introducing or creating new compounds with enhanced toxicity.

Food allergy is defined as an immunologically based adverse reaction in response to dietary antigens or small regions in allergenic proteins, called epitopes, that provoke an immunoglobulin E (IgE)-mediated allergenic response that may be life-threatening. Therefore, the reduction or elimination of allergenic factors in raw whole vegetable compositions may be important for allergic individuals.

### SUMMARY OF THE INVENTION

The present invention includes a method of processing vegetables by applying enzyme(s) to a raw whole vegetable for a time that is sufficient to form an enzyme-degraded vegetable under normal atmospheric pressures followed by deactivation of the enzyme(s). The enzyme-degraded vegetable is further capable of absorbing other components such as water, additives or enzymes that further modify the raw vegetable.

### DETAILED DESCRIPTION

The present invention includes a method of processing vegetables. In the method, an activated aqueous enzyme composition is applied to a raw vegetable composition under normal atmospheric pressure for a time that is effective to form an enzyme-degraded vegetable composition. After degrading, the enzyme-degraded vegetable composition can be processed by one or more additional processing steps that transforms the enzyme-degraded into a vegetable product destined for animal or human consumption.

As disclosed in Serial application Ser. No. 09/196,844, now U.S. Pat. No. 6,033,692, Serial application Ser. No. 09/495,960 now abandoned, 10/619,403, and 11/986,609 which are all incorporated herein by reference, enzymes can be used to hydrate dry edible beans so that subsequent processing of these hydrated edible beans by canning or the like is more easily accomplished without having to use excessive temperatures and/or pressures. Traditional vegetable processing techniques often require the use of high temperatures and/or high pressure during the manufacturing process due in part to the presence of a tough outer layer on vegetables that functions as a barrier.

Such high temperatures and/or pressures increase the cost and complexity of processing vegetables. In addition, such high temperatures and/or high pressures may ultimately reduce the nutritional quality of processed vegetables by lowering phytochemical levels in a manner that reduces consumer acceptability and consumption.

Surprisingly, it has been discovered that application of an activated aqueous enzyme composition to a raw whole vegetable composition that contains appreciable levels of polyphenols is effective to enzymatically tenderize, hydrolyze, degrade, reduce the content of, and or modify the raw whole vegetable composition. This is surprising since technical enzymes are sensitive to polyphenols in raw whole vegetables and can be significantly inhibited by the polyphenolic content present in raw whole vegetables.

The present invention includes enzymatic degradation of raw whole vegetables under normal atmospheric pressures prior to (1) ingestion or consumption or (2) the use of other traditional processing techniques that involve high pressures and/or temperatures to complete production. In addition, since enzymatic processing of vegetables in accordance with the present invention typically occurs under normal atmospheric pressure, specialized equipment is typically not required and subsequent reduction in the cost and complexity of manufacturing vegetables may be realized. Furthermore, enzymatic degradation of vegetables prior to using more traditional processing techniques may also permit a reduction in time, energy and/or other resources that are required to complete processing of raw vegetables.

The present invention further includes a method of reducing the gas-causing sugars in legumes by placing legumes such as soybeans, pinto beans or any other type of legume seed, bean, lentil or pulse in an activated aqueous enzyme composition. The aqueous enzyme composition further includes at least one carbohydrase, a lipase, a protease or any combination of any of these, and water. By “activated” is meant the enzyme(s) is at the optimum pH, temperature, water and concentrations that is effective in enzymatically hydrolyzing, degrading, modifying and/or reducing the desired target substrates in the raw whole legumes. The activated aqueous enzyme composition is allowed to degrade or hydrolyze the raw whole beans or legume seed for a time that is effective to hydrolyze, degrade and/or reduce the gas-causing sugars in the form of raffinose, stachyose and/or verbacose in the raw whole legume. After enzymatic treatment, the activated aqueous enzyme composition is deactivated by any conventional technique that is typically used to process legumes including for example, comminution, solvent extraction, extrusion, boiling, cooking, pressure cooking, canning, or the like.

The present invention further includes a method of enzymatically degrading allergenic protein, such that the levels of allergenic protein are greatly reduced to form hypoallergenic raw whole vegetable compositions.

While not wanting to be bound to theory, it is believed that when one or more enzyme(s) that are capable of degrading one or more target substrates in a first outer layer of a raw whole vegetable composition, are applied to the first outer layer of the raw vegetable composition in accordance with the present invention, such that the first outer layer is in adhesive contact with or connected to the inner portions of the raw whole vegetable compositions, and such that the enzyme(s) degrade the target substrates of the first outer layer of the raw vegetable composition to form an enzyme-degraded vegetable composition having a compromised first outer layer.

Consequently, the use of the aqueous enzyme composition is effective to degrade, tenderize, and/or modify the raw vegetable composition. In addition, the use of the aqueous enzyme composition to degrade the raw vegetable composition renders the raw vegetable composition more absorbent to water or other liquids and permits subsequent in situ modification of the raw vegetable composition by addition of ingredients like vitamins, minerals, other enzymes that catalyze specific reactions or the like.

As used herein, the term “enzyme” means any complex protein produced by a living cell that is capable of at least catalyzing a specific biochemical reaction on one or more target substrates. The term “enzyme” is also meant to encompass any complex protein capable of catalyzing a specific biochemical reaction that is substantially free of any microorganism. All references to enzyme is also understood as encompassing any synthetically- or genetically-produced identical copy of the enzyme that is identical in molecular structure to the enzyme that originated in a living organism.

As disclosed in U.S. Pat. No. 6,033,692, Serial application Ser. No. 09/495,950, 10/619,403, and 11/986,609, the enzyme(s) that may be included as part of the aqueous enzyme composition may be generally characterized as carbohydrase(s). As used herein, the term “carbohydrase” means any enzyme that is capable of at least catalyzing hydrolysis of a carbohydrate-containing target substrate. By “hydrolysis” is meant enzymatic degradation of the carbohydrate-containing target substrate that includes complex carbohydrates like cellulose, hemicellulose, pectin, xylan chains of hemicellulose, and/or polymers of other 5-carbon sugars into smaller or reduced molecular weight pieces and/or into their sugar components like pentoses or hexoses.

Furthermore, the term “hydrolysis” is not meant to include the use of microorganisms that produce carbohydrases to hydrolyze and/or degrade raw vegetable compositions in accordance with the present invention. The application of microorganisms that produces carbohydrases and other enzymes to process raw vegetable compositions is commonly referred to as microbial fermentation.

Additionally, although microbial fermentation may involve some degree of hydrolysis, microbial fermentation is known to further transform sugar components like pentoses or hexoses into organic acids that increases the acidity, reduces the pH, and alters the texture and taste of the fermented vegetable composition. Hence, fermentation is a method to deactivate enzymatic degradation as disclosed in the present invention. Therefore, in accordance with the present invention, fermentation is typically not implemented until after the desired degree of enzymatic degradation is attained.

In contrast, the present invention uses enzymes that are substantially free of microorganisms to hydrolyze, tenderize, and/or degrade the raw vegetable composition. By “substantially free” is meant an enzyme composition that has less than 1000 microbes per gram. For example, suitable enzyme compositions for use in the present invention generally comprise less than 1000, less than 900, less than 800, less than 700, less than 600, less than 500, less than 400, less than 300, less than 200, less than 100, less than 50, less than 30, and less than 10 microbes, coliforms, fungi per gram of enzyme composition. Furthermore, the term “substantially free” is also meant to encompass has substantially zero microorganisms per gram enzyme composition, or reads “negative” for pathogenic microbes, such as Salmonella and E. coli, for example.

Use of the aqueous enzyme composition in accordance with the present invention typically results in a decrease in the acidity of, and/or increase in the pH of the aqueous enzyme composition after processing as disclosed in U.S. Pat. No. 6,033,692, Serial application Ser. No. 09/495, 960, 10/619,403 and 11/986,609.

Preferably, cellulase is one carbohydrase that is used as part of the aqueous enzyme composition. Still more preferably, cellulase that is substantially free of any microorganism is included as part of the aqueous enzyme composition. Most preferably, cellulase that is substantially free of any microorganism is used to degrade, hydrolyze and/or tenderize the raw vegetable composition when practicing the present invention. Cellulase may be derived from a number of different sources, such as fungal sources, plant sources, microbial sources, animal sources, or any combination of any of these.

Besides cellulase, it is believed that other carbohydrases, such as hemicellulase, alpha-galactosidase, invertase, mannanase, beta-gluconase, beta-glucanase, arabanase, polygalacturonase, ferulic acid esterase, xylanase, beta-galactosidase, beta-fructofuranosidase, alpha-amylase, beta-amylase, pectinase, pectin depolymerase, pectin methyl esterase, pectin lyase, glucoamylase, oligo-1,6glucosidase, lactase, beta-d-glucosidase, or any combination of any of these are suitable additional non-exhaustive examples of carbohydrases that may be used separately or in combination with cellulase in accordance with the present invention.

Preferably, the aqueous enzyme composition includes cellulase and any combination of hemicellulase, alpha-galactosidase, mannanase, beta-gluconase, beta-glucanase, arabanase, polygalacturonase, xylanase, beta-galactosidase, beta-fructofuranosidase, alpha-amylase, beta-amylase, pectinase, invertase, pectin depolymerase, pectin methyl esterase, pectin lyase, glucoamylase, oligo-1,6 glucosidase, lactase, or beta-d-glucosidase to degrade the raw vegetable composition under normal atmospheric pressures, prior to (1) human or animal ingestion or consumption or (2) application of traditional processing techniques like fermentation, cooking, pressure-cooking or the like.

In one example, a blend of cellulase and hemicellulase is used in the present invention to degrade, tenderize and/or render the raw vegetable composition more absorbent to water, enzymes, additives or the like. In another example, a blend of cellulase, hemicellulase and pectinase is used in the present invention to degrade the raw vegetable composition so that subsequent processing can be practiced with reduced temperature and/or pressure requirements.

Some non-exhaustive examples of cellulases or carbohydrases that can be used in the present invention include Cellulase AP and/or Cellulase T (Amano Enzymes USA, Chicago, Ill.); Enzeco cellulase CEP and/or Enzeco cellulase CE-2 (Enzyme Development Corporation (EDC), New York, N.Y.); Cellulase 4000 or Crystalzyme Cran (Valley Research Inc., South Bend, Ind.); Viscozyme L, or Cellubrix, Peelzym, Gamanase 1.0L (Novozymes, Franklinton, N.C.); Multifect cellulases (Danisco, Calif.); or Rapidase tropical cloud, Cytolase PC15, Cytolase CL (Gist Brocades, N.J.). Some non-exhaustive examples of suitable pectinases include pectinase 500,000 AJDU/GM or pectinase 3,500 ENDO-PG/GM (Bio-cat), pectinase p-II (Amano Enzymes USA); or Multifect pectinase FE (Danisco). Suitable amylases for the present invention include Enzeco fungal amylase (EDC), amylase DS, Amylase S Amano, Amylase THS Amano, and Amylase AY Amano (Amano Enzymes USA).

Suitable alpha-galactosidases include α-d-galactosidase or α-d-galactosidase DS (Amano Enzymes USA), Enzeco alpha-galactosidase concentrate (EDC); and Validase AGS (Valley Research, Inc). Suitable hemicellulases that can be used in the present invention include Enzeco hemicellulase 20M (EDC); Hemicellulase Amano 90 (Amano Enzymes USA); and Multifect XL (Danisco).

When enzymes are used in accordance with the present invention, enzymes may be applied in any form, such as a granular, concentrate, solid, paste, liquid, as a mist, in vapor form, or as part of the aqueous enzyme composition as noted above. The application form that is selected preferably permits the enzyme to (1) contact the vegetable composition being treated, and (2) remain in contact with the vegetable composition being treated for a time that is sufficient to degrade the target substrate. Preferably, the enzyme(s) is applied to the raw vegetable composition as part of the activated aqueous enzyme composition.

The aqueous enzyme composition may include one or more enzyme component(s), one or more optional catalyst component(s), one or more optional pH-modifying component(s), one or more optional additive(s) or one or more optional solvent component(s). The components of the aqueous enzyme composition may be supplied as individual components, or supplied in various prepared mixtures of two or more components, that are subsequently combined to form the aqueous enzyme composition.

The enzyme component(s) may include only the enzyme(s), the enzyme(s) and water, or may optionally include additional components. The enzyme component(s) may be supplied as individual components, or supplied in various prepared mixtures of two or more components, that are subsequently combined to form the enzyme component(s). Additionally, the enzyme component may be supplied in granular form, vapor form, or as part of an aqueous enzyme component.

The concentration of the enzyme(s) in the enzyme component may generally range from about 0.0001 weight percent to about 100 weight percent, based on the total weight of the enzyme component. The enzyme component may optionally include sucrose, fructose, ash, alcohol, and any other components that are compatible with, and do not interfere with the biochemical rate of catalysis of the enzyme.

Preferably, the concentration of the enzyme component is an amount that is effective to tenderize, hydrolyze, modify and/or degrade the raw vegetable composition. Still more preferably, the concentration of the enzyme component is an amount that is effective to degrade the first outer layer of a raw vegetable composition. Most preferably, the concentration of the enzyme component that is used in accordance with the present invention is an amount that is effective to degrade the first outer layer of a raw vegetable composition, tenderize, hydrolyze, modify and/or degrade the raw vegetable composition, and permit further modification of an inner portion of the raw vegetable composition.

In one example, the enzyme component generally comprises about 100%, about 99%, about 98%, about 97%, about 96%, about 95%, about 90%, about 85%, about 80%, about 75%, about 70%, about 65%, about 60%, about 55%, about 50%, about 45%, about 40%, about 35%, about 30%, about 25%, about 20%, about 15%, about 10%, about 5%, about 4%, about 3%, about 2%, or about 1% of the enzyme composition. In another example, the enzyme component comprises about 50%, about 45%, about 40%, about 35%, about 30%, about 25%, about 20%, about 15%, about 10%, about, 5%, about 1%, about 0.9%, about 0.8%, about 0.75%, about 0.7%, about 0.65%, about 0.6%, about 0.55%, about 0.50%, about 0.45%, about 0.40%, about 0.35%, about 0.30%, about 0.25%, about 0.20%, about 0.15%, about 0.10%, about 0.05%, about 0.04%, about 0.03%, about 0.02%, about 0.01% of the aqueous enzyme composition.

Furthermore, it is to be understood that the concentration of the enzyme component(s) may vary depending on the amount of time that the enzymes remain in contact with the raw vegetable composition. Furthermore, if a short exposure time is employed, then higher concentrations of the enzyme component(s) would be required to achieve the desired degree of degradation, tenderization, hydrolysis and/or modification of the raw vegetable compositions. Similarly, if longer exposure times are employed, then the concentration of the enzyme component(s) would be reduced to arrive at the desired result.

The aqueous enzyme composition may optionally include one or more catalyst component(s) in a form that is readily applied to the raw vegetable composition. A catalyst, when included as part of the aqueous enzyme composition, generally enhances the biochemical rate of catalysis of the enzyme component(s). Increasing the biochemical rate of catalysis of the enzyme component(s) may decrease the application time of the aqueous enzyme composition to the raw vegetable composition or the amount of the aqueous enzyme composition applied to the raw vegetable composition.

Alternatively, the catalyst component may be applied separately from the aqueous enzyme composition, either before, during, or after application of the aqueous enzyme composition to the raw vegetable composition. Additionally, the source(s) of the catalyst may be applied in particulate form, as part of an aqueous composition, or in a vapor form so long as the particular form selected results in application to and uptake by the vegetable composition. Some non-exhaustive examples of catalysts that may be included as part of the aqueous enzyme composition are salts that include calcium ions, copper ions, magnesium ions, iron ions, sodium ions, zinc ions, manganese ions, potassium ions, or any combination thereof. The catalyst component(s) may be supplied as individual components, or supplied in various prepared mixtures of two or more components, that are subsequently combined to form the catalyst component(s).

The aqueous enzyme composition may include one or more pH-modifying component(s) that are capable of adjusting the acidity, hereinafter referred to as the pH, of the aqueous enzyme composition. Furthermore, the pH of the aqueous enzyme composition will vary depending on the enzyme(s) present in the aqueous enzyme composition.

In one example, the pH of the aqueous enzyme composition is about 2.0 to about 7.0. In another example, the pH of the aqueous enzyme composition ranges from about 3 to about 6. In a third example, the pH of the aqueous enzyme composition generally comprises about 7, about 6.5, about 6, about 5.5, about 5, about 4.5, about 4, about 3.5, about 3, about 2.5, or about 2. In addition, extremely low pH values of less than about 1.0 are typically effective in deactivating the enzyme component(s) when practicing the present invention. Consequently, human consumption or addition of strong acids that reduce the pH of the aqueous enzyme composition are believed effective in deactivating the enzyme component(s) of the aqueous enzyme composition.

The pH-modifying component generally includes an acidulant, a basic agent, a buffering agent, a salt, or any combinations thereof that are effective to modify the pH of an aqueous composition and activate the enzyme component of the bioactive composition. Some non-exhaustive examples of ingredients that can be used to form the pH-modifying component include organic acids, such as acetic acid, gluconic acid, tartaric acid, malic acid, ascorbic acid, fumaric acid, succinic acid, citric acid, or the like; phosphoric acid; buffering agents of such organic acids, such as calcium citrate, ferrous gluconate, ferrous citrate, calcium acetate, magnesium acetate, zinc citrate, zinc gluconate, calcium maleate, calcium succinate, sodium acetate, sodium maleate, sodium succinate, iron fumarate, sodium citrate, or the like; and/or any combinations thereof. Basic compounds like sodium hydroxide, calcium hydroxide, potassium hydroxide or the like may also be included as part of the pH-modifying component in the present invention.

Combinations of weak organic acids and their corresponding salts are used to form the pH-modifying component when the goal is to provide a pH buffered system that stays within a particular range. For example, if a goal is to maintain a buffered pH environment that stays within a range of about 4 to about 6, then a 60:40 blend of citric acid:sodium citrate is effective to produce this pH range. This translates into 0.30 weight percent citric acid and 0.20 weight percent sodium citrate, based on the total weight of the raw whole vegetable when the vegetable:water ratio is 1:3.

Some non-exhaustive examples of optional additives that may be included as part of the aqueous enzyme composition include natural and/or artificial flavors; artificial colors; naturally-occurring pigments, such as, for example, chlorophyll, anthocyanin, betalain, betaine, carotenoid, anthoxanthins; herbs; spices; vitamins; minerals; plant extracts; essential oils; sugars such as sucrose, fructose, glucose, or maltose; preservatives; emulsifiers, such as mono-glycerides, distilled mono-glycerides, di-glycerides, distilled di-glycerides, or lecithin; any additive that improves the aqueous enzyme composition application to, uptake by, or subsequent processing of the vegetable composition; or any combination of any of these. The optional additives may be supplied as individual components, or supplied in various prepared mixtures of two or more components, that are subsequently combined to form the optional additives.

The aqueous enzyme composition may also include one or more solvent component(s). The solvent component(s) preferably facilitate homogenous blending of the enzyme component(s), the optional catalyst component(s), the optional pH-modifying component(s), the optional additives, or any combination thereof. The solvent component(s) preferably facilitate aqueous enzyme composition application to, and uptake by the vegetable composition. Some non-exhaustive examples of solvents that may be included in the aqueous enzyme composition include water; oils; alcohol, such as ethanol, methanol, propanol, butanol, or the like; hexane; or any combination thereof. The solvent component(s) may be supplied as individual components, or supplied in various prepared mixtures of two or more components, that are subsequently combined to form the solvent component(s).

Liquid water is the preferred solvent for the aqueous enzyme composition as water is typically required for enzymatic degradation, tenderization and/or hydrolysis. The amount of liquid water included as part of the aqueous enzyme composition depends on an initial concentration of water in the raw vegetable composition, the biochemical rate of catalysis, and/or the desired final product characteristics of the enzyme-degraded raw vegetable composition. Generally, the amount of the aqueous enzyme composition is such that the raw vegetable composition is completely contacted by the aqueous enzyme composition. As an example, when degrading raw edible beans, water is included as part of the aqueous enzyme composition at a range of about 2 to about 5 times the weight of raw edible beans.

In general, any conventional blending apparatus and technique that is suitable for homogeneously blending the enzyme component(s), the optional catalyst component(s), the optional pH-modifying component(s), the optional additives, the optional solvent component(s), or any combination thereof, such as a mixer, may be used to form the aqueous enzyme composition.

As used herein, the term “application” means to apply or expose the activated aqueous enzyme composition to the raw vegetable composition by spraying; knife-coating; spreading; printing; soaking; exposing; immersing; slop-coating; dip-coating; roller-coating; dipping; contacting; brush-coating; squirting; submerging; foam padding; leaf-sprinkling; sprinkling; pouring; slop-padding; or any combination thereof.

The temperature of the aqueous enzyme composition depends on the initial temperature of the vegetable composition, the temperature for the optimum biochemical rate of catalysis of the enzyme component(s), and/or the desired characteristics of the enzyme-degraded vegetable composition. The temperature of the aqueous enzyme composition is at the optimum temperature for a maximum biochemical rate of catalysis of the enzyme component(s) of the aqueous enzyme composition.

Generally, the temperature of the aqueous enzyme composition may range from about 30° F. to about 250° F. In one example, the temperature of the aqueous enzyme composition is about 190° F., about 180° F., about 170° F., about 160° F., about 150° F., about 140° F., about 130° F., about 120° F., about 110° F., about 100° F., about 90° F., about 80° F., about 70° F., about 60° F., about 50° F., or about 40° F. Similarly, the temperature of the aqueous enzyme composition comprises about 88° C., about 82° C., about 76° C., about 71° C., about 66° C., about 60° C., about 54° C., about 50° C., about 49° C., about 40° C., about 37° C., about 32° C., about 30° C., about 27° C., about 21° C., about 15° C., about 10° C., or about 4° C. In a third example, the temperature of the aqueous enzyme composition ranges from about 75° F. to about 150° F. before adding the raw whole vegetable composition.

Although the aqueous enzyme composition may be applied to the raw vegetable composition at a constant temperature, the temperature of the aqueous enzyme composition may be increased at any time during application of the aqueous enzyme composition to the raw vegetable composition. Generally, increasing the temperature increases the biochemical rate of catalysis, and/or water absorption.

However, a negative impact on the texture of the raw vegetable composition may occur if the temperature of the aqueous enzyme composition is too high, such as more than about 250° F., or the temperature of the aqueous enzyme composition is changed too rapidly during application. Furthermore, too high temperatures may inactivate the enzyme component of the aqueous enzyme composition, therefore care is required to avoid premature inactivation of the enzyme component(s) before attaining the desired degree of hydrolysis, tenderization, degradation and/or enzymatic modification when practicing the present invention.

Steam can also be injected into the aqueous enzyme composition to during or after application of the aqueous enzyme composition to the raw vegetable composition to (1) optionally increase the temperature of the aqueous enzyme composition applied to the raw vegetable composition, (2) optionally increase the moisture content of the vegetable composition, (3) optionally gelatinize any starch granules of the vegetable composition, (3) optionally increase the efficacy of the biochemical rate of catalysis of the aqueous enzyme composition, or (3) optionally deactivate the enzyme component in the aqueous enzyme composition.

As noted, inactivation of the enzyme component(s) readily occurs at high temperatures, therefore, care is required to avoid premature inactivation of the enzyme component(s) prior to attaining the desired degree of degradation, tenderization and/or hydrolysis of the raw vegetable composition.

The aqueous enzyme composition is typically applied to the raw vegetable composition at normal atmospheric pressures. By “normal atmospheric pressures” is meant atmospheric pressures of about 14.7 psi. Furthermore, it is to be understood that “normal atmospheric pressures” also includes atmospheric pressures that occurs even under varying altitudes, temperatures, humidities, or the like.

Additionally, the term “normal atmospheric pressures” is not meant to include application of positive or negative pressures to the raw vegetable composition prior to or during application of the aqueous enzyme composition in a manner that facilitates degradation, tenderization, hydration and/or hydrolysis.

As used herein, the term “vegetable” means a plant-based food that originated as a living organism of the Plantae kingdom. All references to “vegetable” are to be understood as encompassing any genetically-altered copy of the plant that originated as a living organism of the Plantae kingdom.

The raw vegetable composition of the present invention typically contains a first outer layer that substantially covers, overlays, and/or is in adhesive contact with a second inner layer of the raw vegetable composition when practicing the present invention. When the first outer layer is in adhesive contact with the second inner layer, adhesive contact may be accomplished through bonding via cementing substances like pectic substances.

The first outer layer of the vegetable composition typically includes a fibrous network of cellulose; xylan chains of hemicellulose; hemicellulose; polysacccharides of five-carbon sugars; lignin; pectic substances, such as protopectin, pectic acid, pectin, or any combination thereof; vitamins; minerals; anti-nutritional components; or any combination of any of these. Some non-exhaustive examples of the first outer layer may include a seed coat of a legume, pulse or lentil; a bran layer of a grain seed; the hull of a soybean; a test a or a seed wall of a nut.

The second inner layer of the raw vegetable composition generally includes a network of starch granules, fat globules, fiber, proteins, vitamins, minerals, water, phytochemicals, anti-nutritional components, or any combination of any of these. In addition, all references to the second inner layer is also understood to encompass the inner portion of the raw vegetable composition and thus, the second inner layer may also include seeds embedded in the vegetable composition. Some non-exhaustive examples of anti-nutritional components of a vegetable composition include allergenic soy protein (7S and 22S fraction of soy protein); flatulence- or gas-causing sugars, such as, for example, raffinose, verbascose and stachyose; lectins; nutrient-binding substances, such as phytic acid; other indigestible polysaccharides; enzyme inhibitors, such as trypsin inhibitor; or toxic compounds, such as goitrogens, solanine, or oxalic acid.

Preferably, the first outer layer is connected or in adhesive contact to the second inner layer or inner portion of raw vegetable compositions when practicing the present invention. By “connected or in adhesive contact” is meant that the raw vegetable composition has a substantial portion of the first outer layer connected to the inner portion or second inner layer of the raw vegetable composition. Additionally, removal of the first outer layer of the raw vegetable composition by peeling, chemicals, grating is preferably avoided when practicing the present invention. In one example, removal of the first outer layer, such as the hulls of soybeans increases leaching of components known to deactivate the aqueous enzyme composition before the desired degree of enzymatic degradation has been attained.

Suitable non-exhaustive vegetable compositions that can be processed in accordance with the present invention may be characterized as “raw”. As used herein, the term “raw” refers to vegetable composition(s) that are uncooked, un-boiled, dry, edible, as being in a natural condition, not processed or any combination of any of these.

Furthermore, it is to be understood that the term “raw” refers to the condition of the first outer layer, the second inner layer or both the first and second layers of the vegetable composition when practicing the present invention. For example, as disclosed in U.S. Pat. No. 6,033,692 raw dry edible beans contain an outer seed coat and inner cotyledon that have not been cooked, processed or subjected to a boiling and/or cooking step prior to application of the aqueous enzyme composition. The aqueous enzyme composition is therefore applied to the raw edible beans in a manner that degrades the seed coat or first outer layer of the raw beans.

In addition, suitable vegetable compositions for enzymatic degradation in the present invention may be characterized as “native”. As used herein, the term “native” is meant to encompass the naturally occurring form of the raw whole vegetable. Suitable non-exhaustive vegetable compositions also include raw whole vegetable compositions. By “whole” is meant that the raw vegetable composition has not been subjected to techniques like maceration, pulverization, grating, grinding or the like and still retains the first outer layer in adhesive contact with the second inner layer. For example, dry edible beans that have not been ground, grated, macerated or pulverized are examples of whole raw vegetable compositions.

The raw whole vegetable compositions may also be characterized in terms of piece counts and size. For example, raw vegetables such as legumes, grains, dry edible beans, soybeans or other raw whole vegetables in particulate form that typically have piece counts that range from about 50 to about 5,000 per pound are suitable for use in the present invention. In one example, the raw whole vegetable compositions have piece counts of less than 1000, about 900, about 800, about 700, about 600, about 500, about 400, about 300, about 200, or about 100 per pound. In another example, the piece count ranges from about 50 to about 2500 per kilogram.

Furthermore, the raw whole vegetables may be characterized in terms of have sizes that range from about 0.3 mm to about 20 mm. In one example, the raw whole vegetable composition has about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, about 3 mm, or about 2 mm. In another example, the raw whole vegetable composition has sizes that range from about 0.5 mm to about 15 mm. In a third example, pinto beans have a piece size of about 10 mm to about 12 mm while navy beans have a piece size of about 3 mm to about 4 mm. In a fourth example, soybeans have a piece size of about 3 mm to 5 mm.

In addition, the raw whole vegetables that may be used to practice the present invention may also be characterized in terms of piece weight. By “piece weight” is meant the weight in grams of one (single) raw whole vegetable composition in particulate form. In general, piece weights of raw whole vegetables ranges from 0.01 grams to 15 grams and preferably, 0.1 grams to 10 grams. In one example, piece weights range from about 10 grams, about 9 grams, about 8 grams, about 7 grams, about 6 grams, about 5 grams, about 4 grams, about 3 grams, about 2 grams, about 1 gram or about 0.5 grams. In another example, cracked hulled soybeans is a suitable example of whole raw vegetable compositions since cracked hulled soybeans are raw and whole as cracked hulled soybeans still contain the outer soybean seed coat along with appreciable levels of polyphenols.

Raw vegetable compositions that are in the form of a seed having less than about 40 weight percent moisture content, and preferably about 30 weight percent moisture content or less may be used in accordance with the present invention. In one example, the raw whole vegetable compositions have about 40%, about 39%, about 38%, about 37%, about 36%, about 35%, about 34%, about 33%, about 32%, about 31%, about 30%, about 25%, about 20%, about 15%, about 14%, about 13%, about 12%, about 11%, about 10%, about 9%, about 8%, about 7%, about 6%, about 5%, about 4%, about 3%, about 2%, or about 1% moisture content.

Examples of seeds include raw beans, as noted above, which are dry edible raw seeds from a plant of a Leguminosae family. As used herein, the term “legume” refers to a vegetable belonging to the family Leguminosae. It is characterized as having a dry, dehiscent fruit derived from a single, simple pistil. When mature, it splits along both dorsal and ventral sutures into two valves. The family Leguminosae characteristically contains a single row of seeds attached along the lower or ventral suture of the fruit. Ordinarily, the legume seeds used for the present invention are the usual dry seeds available in commerce. For example, in the case of beans, these products are referred to as dry beans because the product includes only the mature seeds, the pods having been removed.

Examples of legume seeds useful in the present invention include seeds of the genus Phaseolus, including, without limitation, the common beans such as large white or Great Northern, small white, pinto, red kidney, black, calico, pink cranberry, red mexican, brown, bayo, lima, navy and the like; the genus Pisum, including, without limitation, smooth and wrinkled peas and yellow or green varieties and the like; the genus Vigna, including the black eye beans (or black eye peas as they are sometimes termed), cowpeas, purple hull peas, cream peas, crowder peas, field peas and the like; the genus Lens, including without limitation, lentils; the genus Cicer, including, without limitation, garbanzo beans and chick peas; the genus Soja, including, without limitation, soybeans; and the like. Other examples of legume seeds useful in the present invention include red beans, yellow-eye beans, azuki beans, mung beans, tepary beans, and fava beans and the like. In addition, the term “legume” is meant to encompass the word “pulse” (plural “pulses”) generally used for this class of edible seeds in most English-speaking countries.

Furthermore, the term “legume” or “legume seed” used herein refers to both legumes rich in protein and starch and legumes rich in oil, also referred to as oleaginous legumes. By “legumes rich in protein and starch” is meant whole legumes having a protein content of from 15 to 48% or more and a starch content of from 35 to 75% on a dry matter basis, but most commonly having a protein content of from 20 to 36% and a starch content of from 55 to 70%. Such legumes have been distinguished from oleaginous seeds by having a lipid content only of from 0.5 to 5.0%, and more commonly of from 1.0 to 2.5%. Legumes derived from legumes of the genus Lupinus may also be used in the process according to this invention since such legumes are rich in protein, having a protein content of from 40 to 50%, although they may contain somewhat lower amounts of starch and higher amounts of oil than other legumes.

While preferred raw vegetable compositions include raw vegetable compositions that do not contain a waxy layer and a moisture content of less than about 30 weigh percent, certain raw vegetable compositions like bulgur have been found to undergo rapid hydration when an aqueous enzyme composition containing celluase and hemicellulase is used to soak bulgur. Other suitable raw whole vegetables includes grains such as bulgur, amaranth, millet, rice, brown rice, sorghum, corn, rye, triticale, quinoa or any combination of any of these.

Raw vegetable compositions that are generally in the form of a nut may also have less than about 40 weight percent moisture content and may also be included as part of the raw vegetable composition when practicing the present invention. As used herein, a “nut” means a hard shelled dry fruit or seed with a separable first outer layer that substantially encloses an interior kernel.

Some non-exhaustive examples of vegetable compositions in the form of a nut that may be used in accordance with the present invention include an acorn nut, an almond nut, a brazil nut, a butternut, a cashew nut, a chestnut, a coconut, a filbert nut, a hazelnut, a hickory nut, a macadamia nut, a pecan nut, a pine nut, a pistachio nut, a walnut, or any recognized edible nut from a recognized edible vegetable source.

It is also to be understood that the term “raw vegetable composition” is meant to encompass raw vegetable compositions that may have been washed with steam, hot, warm and/or cold water in an attempt to remove dirt and the like from the raw vegetable composition. Cleaning, washing or dirt removal from the vegetable composition may also include the application of food-grade detergents or chemicals using sprinkler-type equipment or soaking equipment. Such cleaning, washing or dirt removal techniques are believed to not significantly remove the first outer layer of the raw vegetable composition from the second inner layer or inner portions of the raw vegetable compositions, and therefore, use of such cleaning, washing or dirt removal techniques prior to application of the aqueous enzyme composition are permissible when practicing the present invention.

Optional pre-conditioning, which includes optionally cleaning of the raw whole vegetable composition by conventional methods and an optional pre-soaking is meant to include either cleaning, or presoaking or combination thereof. Moreover, if the raw whole vegetable compositions are subjected to cleaning and pre-soaking, the order is not critical, i.e., the cleaning step may precede the pre-soaking step and vice versa.

If the raw whole vegetable compositions are subjected to the optional cleaning step, they are cleaned by standard techniques known in the art, such as by passing the legumes through a filter or by spray washing, to remove the foreign material.

For purposes of this invention, “a dry clean legume” is a legume from the field in which the foreign material adhered to or associated with the legume is removed before undergoing any of the method steps of the present invention hereinbelow, i.e., prior to undergoing any significant exposure to the activated aqueous enzyme composition except that which is used in the cleaning step. Unless indicated to the contrary, the term “dry legumes” refers to a legume having the moisture content of a legume naturally found in the field. Finally, a “pre-soaked legume”, as used herein, refers to a legume which has been subjected to pre-conditioning, as defined hereinbelow. It is preferred that the legume utilized in the present process is a dry legume. It is more preferred that the legume utilized in the present process has a moisture content ranging from about 8% to about 15% by weight. It is even more preferred that the legume used in the present process is a clean dry legume.

The legume may optionally be preconditioned by contacting the legume with water from a preconditioning water source at ambient temperatures. Although the legumes do undergo hydration in this cleaning step, the amount of hydration is not critical in this step and varies, depending upon various factors, e.g., the age of the legume, the storage temperature of the legume, humidity, and the like. This optional preconditioning step that includes a pre-soaking is to achieve a substantially uniform moisture content in the legumes. It is preferred, therefore, that the amount of hydration in this step is monitored and controlled. In a preferred embodiment, the legume is contacted with a sufficient amount of a preconditioning water source for a sufficient period of time to produce pre-conditioned legumes having a moisture content in the range from about 15% to about 30% by weight, using techniques known in the art. The dry legume can be contacted with the water source used in the pre-conditioning step by any method known to the skilled artisan. Examples of useful methods include, but are not limited to, spraying, immersion, repeated dipping, misting, floating, diffusion, steam condensing or combination thereof, with immersion being the most preferred. This preconditioning step, if utilized is effected at ambient temperatures.

Of course, the amount of the preconditioning water source used and the period of time necessary for the dry legumes to be in contact with the initial preconditioning water source to produce the preconditioned legumes will vary depending upon the particular method used to contact the dry legumes with the preconditioning water source. Preferably, the ratio of preconditioning water source to dry legumes is at least about 2:1 to about 4:1 and more preferably from about 2.5:1 to about 3.5:1. Also, preferably, the dry legumes are contacted with the preconditioning water source for a period of time in the range of from about 1 to about 30 minutes and more preferably from about 2 to about 20 minutes and more preferably from about 2 to about 10 minutes.

This optional preconditioning step compensates for variations in the legume, including areas of variations, such as legume size, legume variety, growing area, storage time, storage temperature, storage humidity and the like. This step, if utilized, essentially establishes a common starting point for the process steps.

Legumes and/or optionally preconditioned legumes are next placed in the activated aqueous enzyme composition. The legumes are preferably substantially immersed in the aqueous enzyme composition. Sufficient amount of water is present in the aqueous enzyme composition to effect the increase in moisture content of the legumes. More specifically, the weight ratio of aqueous enzyme composition to legume is sufficient to rehydrate the legumes to attain the moisture levels described herein. Preferably, the weight ratio of aqueous enzyme composition to raw vegetable compositions, such as raw legumes range from about 1:1 to about 10:1, and more preferably from about 1:1 to about 8:1 and most preferably from about 2:1 to about 4:1. Water sources known to the skilled artisan may be utilized in the present invention. By “water source”, it is meant the water used to soak the legumes or any water subsequently added to the soak water. The term “water source” refers to any source of water or moisture, including steam. Preferably, the water source is tap water, deionized water, distilled water or combinations thereof. Although the water may contain mineral salts, it is more preferable that the water not contain too large a mineral content.

Physical and/or chemical pretreatment strategies designed to initiate breakdown, improve the porosity of the first outer layer of raw vegetable compositions, remove certain cellulose and hemicellulose fractions or expose degradation sites have been practiced in the widespread belief that enzymatic degradation cannot proceed without such pre-treatment strategies. Physical pre-treatment strategies include application of positive or negative pressure prior to application of the aqueous enzyme composition to vegetable compositions. Furthermore, chemical pre-treatment strategies include application of strong acid solutions, and/or boiling or cooking of vegetable compositions that typically increase the moisture content of the raw whole vegetable to more than about 40 weight percent moisture prior to application of the aqueous enzyme composition are preferably avoided when practicing the present invention.

The present invention avoids these complicated processing strategies by applying the aqueous enzyme composition to the raw vegetable composition under normal atmospheric pressures without having first subjected the raw vegetable composition to strong acidic solutions, boiling or cooking prior to application of the activated aqueous enzyme composition. Such physical and/or chemical treatments are typically reserved, and preferably conducted after the aqueous enzyme composition has degraded the raw vegetable composition so that the enzyme component(s) are deactivated after attaining the desired degree of enzyme degradation.

It is also to be understood that the term “whole raw vegetable composition” is meant to encompass broken a raw vegetable composition that (1) has a first outer layer that is in adhesive contact with the second layer and (2) an exposed second inner layer or inner portion of the raw vegetable composition. For example, in the manufacture of refried beans, broken portions of whole beans still contain a seed coat and exposed cotyledons. Such broken portions of whole raw beans can be soaked or exposed to the aqueous enzyme composition of the present invention to degrade the seed coat and tenderize the cotyledons prior to human consumption or any subjecting the beans to any other remaining processing steps required for manufacturing refried beans.

As noted above, the length of time the aqueous enzyme composition is applied to the raw vegetable composition typically depends on the raw vegetable composition, the desired degree of degradation, the concentration of the enzyme component(s) and/or the desired characteristics of the enzyme-degraded vegetable composition. The length of time used in practicing the present invention may range from about 1 second to more than about 24 hours. In one example, the length of time generally ranges from about 12 hours, about 11 hours, about 10 hours, about 9 hours, about 8.5 hours, about 8 hours, about 7 hours, about 6 hours, about 5 hours, or about 4 hours when reducing the gas-sugar content in legumes. In another example, the length of time to degrade raw vegetable compositions having a moisture content to of about 30 weight percent or less can range from about 1 second to about 8 hours while the length of time for tenderization may range from about 1 second to about 2 hours as well.

While not wanting to be bound to theory, it is believed that after application of the aqueous enzyme composition in accordance with the present invention, the first outer layer/and or second inner layer or inner portion is transformed of the raw vegetable composition is transformed into a crater-like, mesh-like or sieve-like network of degraded sites. Due to the plurality of holes formed throughout the raw vegetable composition, access and/or absorption of water, additives, enzymes, or any combination of these can occur. The aqueous enzyme composition may also target a wide range of substrates within the raw vegetable composition, therefore, the breakdown of these substrates may occur and aid in the reduction of cook time of the enzyme-degraded raw vegetable composition.

Partial degradation of the first outer layer of the vegetable composition permits absorption of the enzyme component(s), the optional pH-modifying component(s), the optional additives, the optional solvent component(s), or any combination thereof, into the raw vegetable composition while the aqueous enzyme composition is still in contact with the first outer layer. Thus, absorption of the enzyme component(s), the optional pH-modifying component(s), the optional additives, the optional solvent component(s), or any combination thereof, into the raw vegetable composition may occur during or after application of the aqueous enzyme composition to the raw vegetable composition when practicing the present invention.

The rate at which the enzyme-degraded vegetable composition is capable of absorbing the enzyme component(s), the optional pH-modifying component(s), the optional additives, the optional solvent component(s), or any combination thereof, may be expressed as the absorbency of the raw vegetable composition. As used herein, the absorbency of the vegetable composition may be characterized in units of grams of the enzyme component, the optional pH-modifying component, the optional additive, or the optional solvent component per minute of application time. The specific absorbency of a raw vegetable composition is defined herein as the absorbency of an enzyme-degraded vegetable composition per gram of enzyme-degraded vegetable composition.

The benefits of the enzyme-degraded raw vegetable composition include an increase in the absorbency of the raw vegetable composition of a component, such as, for examples, water, additives, or other enzymes that may be used to further process the raw vegetable composition. In addition, processing the enzyme-degraded raw vegetable composition by conventional means, after enzymatic degradation, such as by freezing, hydrating, steaming, freeze-drying, canning, frying, boiling, drying, extrusion, cooking, baking, roasting, pulverizing, fermenting, other enzymes, pasteurizing, extracting, milling, puffing, steam-pressure cooking, or any combination thereof, is improved since the first outer layer of the raw vegetable composition that typically functions as a barrier during conventional is degraded.

Once sufficient degradation of the raw vegetable composition has occurred to form the enzyme-degraded raw vegetable composition, the enzyme-degraded raw vegetable composition may be separated from the aqueous enzyme composition and further subjected to processing steps, such as, for example, blanching, that inactivates any enzyme component(s) remaining in the enzyme-degraded raw vegetable composition. Alternatively, transferring both the raw enzyme-degraded vegetable composition and the aqueous enzyme composition to equipment that permits further processing by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof, is also effective in deactivating any enzyme component(s) remaining in the enzyme-degraded raw vegetable composition and the aqueous enzyme composition.

The aqueous enzyme composition may also include an emulsifier component, particularly when oleaginous legumes or raw vegetables having appreciable lipid content are to be enzyme degraded in accordance with the present invention. Some non-exhaustive examples of suitable emulsifiers include lecithin, organic lecithin, deoiled lecithin, polysorbate 60, polysorbate 80, propylene glycol, sodium dioctylsulfosuccinate, mono-glycerides, distilled mono-glycerides, di-glycerides, distilled di-glycerides, sodium lauryl sulfate, lactylic esters of fatty acids, polyglycerol esters of fatty acids, triacetin, and combinations thereof.

The emulsifier component can be added at a concentration of the emulsifier component can range from about 0.01 to about 10 percent by weight, based on the total weight of the raw whole vegetables when oleaginous legumes and/or raw whole vegetables with appreciate lipid content are being used. In one example, the emulsifier component ranges from about 5%, about 4%, about 3%, about 2%, about 1%, about 0.5%, about 0.25%, or about 0.1%, based on the total weight of the raw whole vegetable composition. The emulsifier component may be included in liquid, liquefied, melted, molten, solid, or in granular form. Suitable emulsifiers for use in the present invention include organic lecithin from Clarkson Soy Products (IL) and Solec™ 8160 from the Solae Company (St. Louis, Mo.).

The present invention is more particularly described in the following examples that are intended as illustrations only since numerous modifications and variations within the scope of the present invention will be apparent to those skilled in the art.

### a Method of Enzymatically Degrading a Raw Vegetable Composition

The aqueous enzyme composition may include one or more enzyme component(s). Furthermore, if an aqueous enzyme composition containing a plurality of enzyme components, such as a first enzyme component and a second enzyme component are applied to a raw vegetable composition in accordance with the present invention, both the first or second enzyme components may be used to enzymatically process the raw vegetable composition and form an enzyme-processed vegetable composition. Typically application of the aqueous enzyme composition that includes first and second enzyme components occur under normal atmospheric pressures and temperatures that can range from about 40° F. (4° C.) to about 200° F. (94° C.) and preferably from about 40° F. (4° C.) to about 190° F. (88° C.). In addition, the pH values range from about 2.0 to about 6.0.

More specifically, when the aqueous enzyme composition contains a first enzyme component that is designed to degrade the first outer layer of raw vegetable compositions, such as a first enzyme component that includes cellulase, hemicelullase and/or pectinase, the first enzyme component typically degrades the first outer layer of the raw vegetable composition to form an enzyme-degraded raw vegetable composition. Next, if the aqueous enzyme composition further includes a second enzyme component that is designed to degrade, and/or hydrolyze any target substrates located in the second inner layer or inner portion of the raw vegetable composition, the second enzyme component is able to penetrate the inner portion through the degraded sides of the enzyme-degraded raw vegetable composition and degrade the target substrates. The target substrate may be one or more anti-nutritional components, such as allergenic soy or legume protein located in the second inner layer of the vegetable composition.

In another example, two or more separate aqueous enzyme compositions may be applied to the raw vegetable composition when practicing the present invention. For example, a first aqueous enzyme composition that includes cellulase and hemicellulase may be applied to a raw vegetable composition having a moisture content of less than about 30 weight percent under normal atmospheric pressures and temperatures to form an enzyme-degraded raw vegetable composition. Next, a second aqueous enzyme composition that contains an enzyme component that is effective to degrade and/or hydrolyze target substrates either in the first outer layer or the second inner layer can be applied to the enzyme-degraded vegetable composition. The second aqueous enzyme composition is able to penetrate the enzyme-degraded vegetable composition and therefore, is capable of degrading and/or hydrolyzing desired target substrates in the enzyme-degraded vegetable composition.

In a third example, an aqueous enzyme composition comprising at least one cellulase and at least one protease is applied to raw whole vegetable compositions is effective to hydrolyze allergenic proteins in the raw whole vegetable compositions.

In a fourth example, an aqueous enzyme composition comprising at least one cellulase, at least one protease, at least one carbohydrase, and at least one lipase is applied to raw whole vegetable compositions is effective to hydrolyze allergenic proteins in the raw whole vegetable compositions.

In a fifth example, an aqueous enzyme composition comprising cellulase, hemicellulase, pectinase, at least one protease, and at least one other carbohydrase, such as amylase or alpha-galactosidase is applied to raw whole vegetable compositions is effective to hydrolyze allergenic proteins in the raw whole vegetable compositions.

It is believed that the compromised first outer layer of the enzyme-degraded raw vegetable composition allows additional enzyme components to enter and degrade the interior of the raw whole vegetable composition. Additionally, water included as part of the aqueous enzyme composition(s) may also enter through the degraded first outer layer to hydrate the enzyme-degraded raw vegetable composition. If water is absorbed by the enzyme-degraded raw vegetable composition, the water in the enzyme-degraded raw vegetable composition may facilitate further degradation of the interior of the enzyme-degraded raw vegetable to composition by the additional enzymes that are present.

After sufficient enzymatic degradation by additional enzymes, such as the second enzyme component, or the second aqueous enzyme composition, an enzyme-processed raw vegetable composition is formed that can be further subjected to other processing steps, such as, for example, blanching, that inactivates any enzyme component(s) remaining in the enzyme-processed vegetable composition.

Preferably, the enzymes that is included as part of the first enzyme component includes the above noted enzymes that are effective in degrading the first outer layer of raw vegetable compositions. The enzyme(s) that may be included as part of the second enzyme component, second aqueous enzyme composition, or other added enzymes are carbohydrases, proteases, lipases or any combination thereof. Any of the examples of carbohydrases as suitable for use during application of the first enzyme component may be used as part of the second enzyme component in any combination with the first enzyme component, for degradation of any anti-nutritional component of the raw vegetable composition in accordance with the present invention.

As used herein, the term “protease” means any enzyme that is capable of at least catalyzing degradation of a protein-containing target substrate into smaller, reduced and/or lower molecular weight pieces or fragments. One particular form of a protease that may be used as part of the second enzyme component in accordance with the present invention is an endoprotease. As used herein, an “endoprotease” means any enzyme that is capable of degrading an internal peptide bond on a target substrate having one or more peptide bonds to form one or more smaller, reduced and/or lower molecular weight piece(s) or fragment(s). Another particular form of a protease that may be used as part of the second enzyme component in accordance with the present invention is an “exoprotease”. As used herein, an “exoprotease” means any enzyme that is capable degrading a peptide bond located at a terminal portion of a target substrate having one or more peptide bonds to form one or more smaller, reduced and/or lower molecular weight pieces(s) or fragment(s). Either the endoprotease or the exoprotease may be derived from a number of different sources, such as fungal sources, plant sources, microbial sources, animal sources, or any combination of any of these. Suitable proteases that can be used in the present invention include Enzeco purified papain concentrate, Panol purified papain, Enzeco fungal acid protease, and Enzeco fungal protease 120, bromelain and fungal protease 180 available from Enzyme Development Corporation (EDC) of New York, N.Y.; Alcalase®, Neutrase® Esperase®, Protamex, Novozym® FM, Flavourzyme®, and Kojizyme®, all available from Novo Nordisk Biochem North America of Franklinton, N.C.

Besides the carbohydrases and proteases, it is believed that lipases are also suitable for use in the present invention particularly when oleaginous legumes or raw whole vegetable compositions with a significant amount of lipid are being processed in accordance with the present invention. Some non-exhaustive examples of suitable lipases for the present invention include Yeast lipase 200,000 FIP/GM and/or Lipase 150,000 FIP/GM (Bio-cat, Troy, Va.); Lipase F-AP15, Lipase M Amano 10, Lipase G Amano 50, Lipase F Amano, Lipase A Amano 12, Lipase R Amano, Lipase AY Amano 30 (Amano Enzymes USA); Fungal lipase 8000 (Valley Research, Inc); or Enzeco lipase concentrate (EDC).

The enzyme-processed vegetable composition may also be further processed by freezing, hydrating, steaming, freeze-drying, canning, frying, boiling, drying, extrusion, cooking, baking, roasting, pulverizing, fermenting, more enzymes, pasteurizing, extracting, milling, puffing, steam-pressure cooking, or any combination thereof after enzymatic degradation has occurred. These additional processing steps are also generally effective in deactivating any enzyme component(s) in the enzyme-processed vegetable composition. Partial degradation of anti-nutritional components in the first outer layer or the second inner layer of the vegetable composition may also occur during application of aqueous enzyme compositions that includes a plurality of enzymes, such as first and second enzyme components or the second aqueous enzyme composition.

As a first example, an enzyme-degraded raw vegetable composition that includes gas-causing substrates located in an inner portion of the raw vegetable composition is formed by applying a first aqueous enzyme composition that degrades the raw vegetable composition in accordance with the present invention. If a second aqueous enzyme composition that includes any enzyme component capable of degrading any flatulence-causing substrates that cause flatulence in human, such as alpha-galactosidase, beta-fructofuranosidase, beta-galactosidase, invertase, or any combination thereof, is applied to the enzyme-degraded raw vegetable composition either during or after the first aqueous enzyme composition is applied to the raw vegetable composition, degradation of gas-causing substrates, such as raffinose, verbascose and/or stachyose of the enzyme-degraded raw vegetable composition typically occurs.

Generally, a plurality of enzymes are applied to raw whole vegetable compositions or enzyme-degraded vegetable compositions for a time that is sufficient for the enzymes to degrade target substrates, such as protein, lipids, carbohydrates, or any combination of any of these. Exemplary enzymatic degradation times can range from about 1 minute to about 24 hours. In one example, enzymatic degradation times ranges from about 12 hours, about 11.5 hours, about 11 hours, about 10 hours, about 9.5 hours, about 9 hours, about 8 hours, about 7 hours, about 6, about 5 hours, or about 4 hours. In another example, enzymatic degradation times ranges from about 8 hours, about 7 hours, about 6 hours, about 5 hours, about 4 hours, about 3 hours, or about 2 hours. In a third example, enzymatic degradation times ranges from about 24 hours, about 23 hours, about 22 hours, about 21 hours, about 20 hours, about 19 hours, about 18 hours, about 17 hours, about 16 hours, about 15 hours, about 14 hours, about 13 hours, about 12 hours, about 11 hours, about 10.5 hours, or about 10 hours.

In addition, it has been found that the activated enzyme composition containing the combination of carbohydrases, such as cellulase, hemicellulase, pectinase, amylase and alpha-galactosidase along with a protease, such as papain to reduce the gas-causing sugars levels in legumes is also effective in reducing allergenic proteins in raw whole native vegetable compositions.

In one example, the activated enzyme composition includes a combination of carbohydrases, such as cellulase, hemicellulase, pectinase, amylase and alpha-galactosidase along with a protease, such as papain to reduce the gas-causing sugars or allergenic protein levels in dry edible beans. In order to effectively degrade the flatulence-causing oligosaccharides from the seeds, an endoprotease may be added along with a lipase, such as when soybeans are being enzymatically degraded in accordance with the present invention. Therefore, a third embodiment includes the activated enzyme composition containing carbohdyrases, such as cellulase, hemicellulase, pectinase, amylase, alpha-galactosidase, along with a protease, such as papain and a lipase, such as enzeco lipase concentrate to substantially reduce the gas-causing sugars and/or allergenic soy protein in soybeans. By “substantially”, it is meant that at least 90% by weight in anti-nutritional components, such as as-causing sugars, gas-causing oligosaccharides, or allergenic soy protein relative to raw whole vegetable compositions not subjected to enzymatic degradation methods disclosed herein content, has been removed. In one example, reduction in anti-nutritional components is at least about 90%, about 91%, about 92%, about 93%, about 94%, about 95%, about 96%, about 97%, about 98%, or about 99% by weight of the raw whole vegetable composition. In another example, allergenic soy protein in the form of 7S and 11S soy protein fractions are removed by at least about 90%, about 91%, about 92%, about 93%, about 94%, about 95%, about 96%, about 97%, about 98%, or about 99% by weight, based on the total weight of the raw whole soybean. In a third example, at least about 90%, about 91%, about 92%, about 93%, about 94%, about 95 by weight raffinose and/or stachyose have been removed from dry edible beans.

It is preferred that the gas-causing sugar or oligosaccharide concentration in raw whole vegetable compositions comprising raffinose, stachyose and/or verbacose produced after implementing the present process, is less than about 0.5% by dry weight of the legume, and more preferably less than 0.05% by dry weight of the legume and most preferably less than about 0.01% by weight.

The effective conditions described herein permit the addition of exogenous enzymes that degrade raw whole vegetable compositions that allows gas-causing oligosaccharides or sugars to diffuse into the aqueous enzyme composition water or be degraded in situ by exogenous enzymes. As used herein, the term “exogenous enzymes” refers to the addition of an external source of enzymes. If gas-causing sugars diffuse into the water, they are degraded by any enzymes that are present in the soak water. Exposure to the activated enzyme composition may occur with or without stirring.

The aqueous enzyme composition includes water, enzymes and the pH within the optimum pH range for efficacy the enzymes. The temperature of the aqueous enzyme composition generally ranges from about 80° F. (26° C.) to about 140° F. (60° C.) when practicing the present invention. For example, when Viscozyme is the enzyme that included as part of the aqueous enzyme composition, the temperature of the aqueous enzyme composition generally ranges from about 80° F. (26° C.) to about 125° F. (51° C.) When Multifect GC is used, the temperature generally ranges from about 95° F. (35° C.) to about 140° F. (60° C.). Preferably, the temperature of the aqueous enzyme composition ranges from about 95° F. (35° C.) to about 135° F. (58° C.). In addition, while the preferred ranges are provided above, it is to be understood that the temperature of the beans also influences the temperature at which the aqueous enzyme composition is supplied. For example, if the beans are 20° F. (−6° C.) to 40° F. (4° C.) below the temperature range at which optimum enzyme activity is observed, then the aqueous enzyme composition can be supplied at slightly higher temperatures to compensate for the differences in temperature.

As noted, during enzymatic degradation, the raw whole vegetable compositions, such as dry edible beans or legumes are hydrated to a moisture content of at least about 30 weight percent and preferably to at least about 40 weight percent in order to attain maximum gas-sugar reduction. While not wanting to be bound to theory, it is believed that a moisture content of at least about 40 weight percent is also effective in enhancing maximum enzyme degradation.

The present invention includes the addition of amylases that are capable of degrading starch. By randomly degrading starch, the formation of random pockets or channels or pores occurs within the raw whole vegetable compositions in a manner that allows migration of water and or enzymes during soaking in the aqueous enzyme composition. As this method includes the reduction of gas-causing sugars in legume or soybeans destined for animal consumption, formation of random channels within the raw whole soybean is believed to enhance digestion since digestive enzymes present in the animal will have better access due to the presence of random channels therein to improve digestion. It is also noted that the presence of random channels within raw whole vegetable compositions also aids in further enzymatic degradation with the plurality of enzymes in the aqueous enzyme composition.

In another example, an aqueous enzyme composition containing cellulase, proteases, amylase, alpha-galactosidase, and pectinase applied to a raw whole vegetable composition, such as raw whole hulled soybeans is effective to hydrolyze allergic soy protein into one or more peptides having a molecular weight of less than about 70 KDa. Soy proteins generally include the 2S (Bowman-Birk Inhibitor), 7S (β-conglycinin), 11S (glycinin) and 15S (soy protein polymers) fractions. There are currently 38 soy proteins that have been identified as allergens (FAARP Allergen Protein Database 2010) with molecular weights ranging from 7 kDa to 71 kDa. The 11S and 7S globulin fractions account for the source of most allergenic proteins. The 11S globulins include the hexameric protein glycinin and each subunit has an acidic and basic polypeptide linked by a disulfide bond. The 7S globulins are primarily β-conglycinin which comprises three subunits: α, α′ and β.

Major soy allergens that bind to human IgE include Gly m Bd 30K. Gly m Bd 30K is the immunodominant allergen that accounts for 65% of total allergenic response in soy-sensitive individuals. Additional allergens include Gly m 1.0101, Gly m 1.0102 and Gly m 2 which are soybean hull proteins. Further allergens include Gly m Bd 28k (7S globulin fraction), Gly m 3 (profilin), Gly m 4 (soybean protein SAM22), Gly m 5 (β-conglycinin), and Gly m Bd 60K (derived from 7S globulin fraction) which is found in 25% of soy-sensitive individuals.

In this example, enzymatic degradation is effective to reduce the allergenic soy protein, as measured by 7S and 11S fractions, by about 99%, about 98%, about 97%, about 96%, about 95%, about 94%, about 93%, about 92%, about 91%, about 90%, or about 89% by weight, relative to raw whole soybeans that have not been enzymatically hydrolyzed.

In another example, enzymatic degradation using an aqueous enzyme composition comprising cellulase, proteases, alpha-galactosidase, and pectinase applied to a raw whole vegetable composition, such as raw whole hulled soybeans, the method is effective to reduce the allergenic soy protein, as measured by 7S and 11S fractions, by about 99%, about 98%, about 97%, about 96%, about 95%, about 94%, about 93%, about 92%, about 91%, about 90%, about 80%, about 70%, about 60%, about 50%, about 40%, about 30%, about 20%, or about 10% by weight, relative to raw whole soybeans that have not been enzymatically hydrolyzed.

In a third example, enzymatic degradation using an aqueous enzyme composition comprising cellulase, proteases, amylase, alpha-galactosidase, and pectinase applied to a raw whole vegetable composition, such as raw whole hulled dry edible beans, the method is effective to reduce the allergenic protein, by about 99%, about 98%, about 97%, about 96%, about 95%, about 94%, about 93%, about 92%, about 91%, about 90%, about 80%, about 70%, about 60%, about 50%, about 40%, about 30%, about 20%, or about 10% by weight, relative to raw whole dry edible bean that have not been enzymatically hydrolyzed.

Other examples are presented in Tables 1 to 3 below. All enzyme concentrations are in weight percent of raw whole vegetable composition unless otherwise noted. All sugar concentrations are in weight percent of the raw whole vegetable composition unless otherwise noted. Papain concentrate and fungal amylase are available from Enzyme Development Corporation. Alpha-galactosidase DS is available from Amano enzymes USA. Temperatures are initial readings unless otherwise noted. Pectinase P-II is available from Bio-Cat. Alpha-galactosidase (EDC) and Alpha-amylase (EDC) are available from Enzyme Development Corporation. Alpha-gal™ and Viscozyme L are available from Novo Nordisk. Citric acid, sodium citrate and calcium citrate are supplied by Tate and Lyle. Pectinase P-10 is available from Enzyme development Corporation. Pectinase P-II is available from Bio-Cat.

Allergenic soy protein is determined as follows—Bean samples are dried and/or ground to remove excess moisture. Lipids are extracted by soxhlet apparatus for 4 hours using diethyl ether as an extraction solvent. The remaining powder is dried of solvent and prepared for protein extraction. For extraction, 2-3 g of dry, defatted soy is weighed and suspended in a 30 mM tris-hydrochloride buffer at pH 8.0 with 10 mM mercaptoethanol. The suspension is shaken for 1 hour at room temperature to extract all proteins present and centrifuged at 12,000×g for 5 minutes (min) The supernatant is placed in a new tube. Centrifugation is repeated using 1-3 ml chloroform to remove remaining lipids. The aqueous phase is collected, the pH adjusted to 6.4 with hydrochloric acid and centrifuged for 5 min at 12,000×g. The pellet is resuspended in a minimal amount of buffer, and set aside as the 7S fraction. The remaining supernatant is adjusted to a pH of 4.8 with hydrochloric acid and centrifuged to pelletize the protein. Next, the supernatant is discarded while the pellet is resuspended in a minimal amount of 4N sodium hydroxide then adjusted to 6.2 with hydrochloric acid. This solution is centrifuged one more time (12,000×g for 5 min) and a 1 ml portion will be set aside as the 11S fraction. The 7S and 11S fractions is dried to remove mercaptoethanol and resuspended separately in 1 ml of 30 mM tris-hydrochloride buffer at pH 8.0 without mercaptoethanol. Next, each solution is diluted appropriately and tested for protein with the MicroBCA kit from Thermo Scientific.

TABLE 1
ENZYMATIC DEGRADATION OF RAW WHOLE DRY BEANS

| | | | raw whole | | | | | | |
|---|---|---|---|---|---|---|---|---|---|
| | raw whole | raw whole | great | raw whole | raw whole | raw whole | raw whole | raw whole | raw whole |
| Composition | Black | pinto | northern | navy | dark red | pinto | pinto | pinto | light red |
| Viscozyme L (mL) | 0 | 0 | 2.5 | 0 | 0 | 0 | 0 | 0 | 0 |
| Cellulose AP 10 | 0.025 | 0.025 | 0 | 0.025 | 0.025 | 0.097 | 0.097 | 0.097 | 0.025 |
| Pectinase P-10 | 0.045 | 0.045 | 0 | 0.045 | 0.045 | 0 | 0 | 0 | 0.045 |
| Hemicellulase 20M | 0.045 | 0.045 | 0 | 0.045 | 0.045 | 0 | 0 | 0 | 0.045 |
| Papain | 0.045 | 0.045 | 0 | 0.045 | 0.045 | 0 | 0 | 0 | 0.045 |
| Alpha-Gal^{tm (}mL) | 0 | 0 | 1.25 | 0 | 0 | 0 | 0 | 0 | 0 |
| Alpha-galactosidase | 0.045 | 0.045 | 0 | 0.045 | 0.045 | 0 | 0 | 0 | 0.045 |
| Alpha-amylase | 0.125 | 0.125 | 0 | 0.125 | 0.125 | 0 | 0 | 0 | 0.125 |
| Fungal amylase (EDC) | 0 | 0 | 0 | 0 | 0 | 0.162 | 0.162 | 0.162 | 0 |
| Alpha-galactosidase-DS | 0 | 0 | 0 | 0 | 0 | 0.0623 | 0.0623 | 0.0623 | 0 |
| Papain concentrate | 0 | 0 | 0 | 0 | 0 | 0.0623 | 0.0623 | 0.0623 | 0 |
| Citric Acid | 0.3 | 0.3 | 0 | 0.3 | 0.3 | 0.29 | 0.29 | 0.29 | 0.3 |
| Sodium Citrate | 0.2 | 0.2 | 0 | 0.2 | 0.2 | 0.293 | 0.293 | 0.293 | 0.2 |
| Vinegar | no | no | yes | no | no | 0 | 0 | 0 | no |
| bean:water ratio | 1:3 | 1:3 | 1:3 | 1:3 | 1:3 | 1:3 | 1:3 | 1:3 | 1:3 |
| initial pH | 4 to 6 | 4 to 6 | 5 | 4 to 6 | 4 to 6 | 4.61 | 4.64 | 4.73 | 4 to 6 |
| Temperature | 75° F. to | 75° F. to | 119° F. to | 75° F. to | 75° F. to | 75° F. to | 116° F. | 115.3° F. | 75° F. to |
| | 125° F. | 125° F. | 123° F. | 125° F. | 125° F. | 125° F. | | | 125° F. |
| Enzymatic degradation | 8 hours | 8 hours | 8 hours | 8 hours | 8 hours | 8 hours | 8 hours | 8 hours | 8 hours |
| time | | | | | | | | | |
| % raffinose by weight | <0.1% | 0 | Not | <0.1% | <0.1% | 0 | 0 | 0 | <0.1% |
| | | | determined | | | | | | |
| % stachyose by weight | <0.1% | 0.26 | Not | <0.1% | <0.1% | 0 | 0 | 0 | <0.1% |
| | | | determined | | | | | | |

TABLE 2
ENZYMATIC DEGRADATION OF RAW WHOLE VEGETABLE
COMPOSITIONS

| | raw whole | raw whole | raw whole | raw whole | raw whole | raw whole | raw whole | raw whole | raw whole |
|---|---|---|---|---|---|---|---|---|---|
| Composition | black | pinto | soybeans | soybeans | soybeans | soybeans | soybeans | soybeans | soybeans |
| Cellulase AP 10 | 0.02 | 0.08 | 0.04 | 0.04 | 0.04 | 0.04 | 0.045 | 0.045 | 0.045 |
| Pectinase P-10 | 0.04 | 0.06 | 0.05 | 0.05 | 0.07 | 0.05 | 0.045 | 0.045 | 0.045 |
| Pectinase P-II | 0 | 0 | 0 | 0 | 0 | 0 | 0 | 0 | 0 |
| Hemicellulase 20M | 0 | 0 | 0.05 | 0.05 | 0.07 | 0.05 | 0.045 | 0.045 | 0.045 |
| Hemicellulase 2.5X | 0.04 | 0.06 | 0 | 0 | 0 | 0 | 0 | 0 | 0 |
| Protease blend | 0 | 0 | 0.13 | 0.16 | 0.19 | 0.16 | 0 | 0 | 0 |
| Papain | 0.04 | 0.04 | 0 | 0 | 0 | 0 | 0.045 | 0.045 | 0.045 |
| Bromelain (EDC) | 0 | 0 | 0 | 0 | 0 | 0 | 0 | 0 | 0 |
| Fungal protease 120 | 0 | 0 | 0 | 0 | 0 | 0 | 0 | 0 | 0 |
| (EDC) | | | | | | | | | |
| Fungal protease 160 | 0 | 0 | 0 | 0 | 0 | 0 | 0 | 0 | 0 |
| (EDC) | | | | | | | | | |
| Alpha-galactosidase | 0.04 | 0.04 | 0.05 | 0.05 | 0.05 | 0.05 | 0.045 | 0.045 | 0.045 |
| (EDC) | | | | | | | | | |
| alpha-amylase (EDC) | 0.12 | 0.12 | 0.125 | 0 | 0 | 0 | 0.125 | 0.125 | 0.125 |
| Citric Acid | 0.3 | 0.3 | 0.3 | 0.2 | 0.2 | 0.2 | 0.2 | 0.2 | 0.2 |
| Calcium citrate | 0 | 0 | 0.2 | 0 | 0 | 0 | 0 | 0 | 0 |
| Sodium Citrate | 0.2 | 0.2 | 0 | 0.2 | 0 | 0 | 0 | 0 | 0 |
| Lecithin | 0 | 0 | 0.2 | 0.3 | 0.3 | 0.2 | 0 | 0 | 0 |
| bean:water ratio | 1:3 | 1:3 | 1:3 | 1:3 | 1:3 | 1:3 | 1:3 | 1:3 | 1:3 |
| initial pH | 4.71 | 4.71 | 5 | 4 to 6 | 4 to 6 | 4 to 6 | 4 to 6 | 4 to 6 | 4 to 6 |
| Temperature | 124.1° F. | 120.3° F. | 119° F. to | 75° F. to | 75° F. to | 75° F. to | 75° F. to | 75° F. to | 75° F. to |
| | | | 123° F. | 125° F. | 125° F. | 125° F. | 125° F. | 125° F. | 125° F. |
| Enzymatic degradation | 8 hours | 8 hours | 8 hours | 8 hours | 8 hours | 8 hours | 8 hours | 8 hours | 8 hours |
| time | | | | | | | | | |
| % raffinose by weight | 0 | 0 | <0.1% | <0.1% | <0.1% | 0.14 | 0.231 | 0.162 | 0.209 |
| % stachyose by weight | 0 | 0 | <0.1% | <0.1% | <0.1% | 0.5 | 0.959 | 0.542 | 0.711 |

TABLE 3
ENZYMATIC DEGRADATION OF RAW WHOLE VEGETABLE COMPOSITIONS

| | raw whole | raw whole | raw whole | raw whole |
|---|---|---|---|---|
| Composition | black beans | pinto beans | soybeans | soybeans |
| Cellulase AP 10 | 0.02 | 0.08 | 0 | 0.045 |
| Pectinase P-10 | 0.04 | 0.06 | 0 | 0.045 |
| Pectinase P-II | 0 | 0 | 0 | 0 |
| Hemicellulase 20M | 0.04 | 0.06 | 0 | 0 |
| Hemicellulase 2.5X | 0 | 0 | 0 | 0.09 |
| Papain | 0.04 | 0.04 | 0 | 0.045 |
| Bromelain (EDC) | 0 | 0 | 0 | 0.02 |
| Fungal protease 120 (EDC) | 0 | 0 | 0 | 0.02 |
| Fungal protease 160 (EDC) | 0 | 0 | 0 | 0.02 |
| Alpha-galactosidase (EDC) | 0.04 | 0.04 | 0 | 0.045 |
| alpha-amylase (EDC) | 0.12 | 0.12 | 0 | 0.125 |
| Citric Acid | 0.3 | 0.3 | 0 | 0.3 |
| Calcium citrate | 0.2 | 0 | 0 | 0 |
| Sodium Citrate | 0 | 0.2 | 0 | 0.2 |
| bean:water ratio | 1:3 | 1:3 | not soaked | 1:3 |
| initial pH | 4.71 | 4.71 | not soaked | 4 to 6 |
| Temperature | 124.1° F. | 120.3° F. | not soaked | 75° F. to 125° F. |
| Enzymatic degradation time | 8 hours | 8 hours | not soaked | 8 hours |
| % raffinose | 0 | 0 | not determined | not determined |
| % stachyose | 0 | 0 | not determined | not determined |
| mg 7S soy protein fraction | not determined | not determined | 23.27 ± 1.08 | 1.7 ± 0.02 |
| per gram bean | | | | |
| % reduction 7S soy protein | not determined | not determined | 0 | 93 |
| % reduction 11S soy protein | not determined | not determined | 0 | 99 |
| mg 11S soy protein | not determined | not determined | 14.21 ± 0.34 | 0.04 ± 0.01 |
| fraction per gram bean | | | | |

Although the present invention has been described with reference to preferred embodiments, workers skilled in the art will recognize that changes may be made in form and detail without departing from the spirit and scope of the invention.

What is claimed is:

1. A method of enzymatically degrading a raw vegetable composition, the method comprising:
providing a raw whole vegetable composition in native form having a moisture content of less than about 30 weight percent, wherein the raw whole vegetable composition comprises a first outer layer connected or in adhesive contact to an inner portion of the vegetable composition;
immersing an aqueous enzyme composition comprising water, at least one protease, cellulase, and at least one carbohydrase to the raw whole vegetable composition under normal atmospheric pressures for a time that is sufficient to degrade the raw whole vegetable composition, wherein the aqueous enzyme composition is at an initial pH of between about 2.0 and 6.0; and
deactivating the aqueous enzyme composition.

2. The method of claim 1 wherein the raw whole vegetable composition is a legume, a soybean, an edible seed, lentil, pulse, or any combination of any of these.

3. The method of claim 1 wherein the aqueous enzyme composition is effective to hydrolyze protein, a hydrophobic amino acid containing protein, a hydrophobic amino acid-containing peptide, allergenic soy protein, or any combination of any of these.

4. The method of claim 1 wherein the aqueous enzyme composition is effective to hydrolyze raffinose, stachyose, verbascose, or any combination of any of these.

5. The method of claim 2 wherein the aqueous enzyme composition is effective to hydrolyze allergenic soy protein.

6. A method of enzymatically processing a vegetable composition, the method comprising:
providing a raw whole vegetable composition in native form having a moisture content of less than about 40 weight percent, wherein the raw whole vegetable composition comprises a first outer layer connected or in adhesive contact to an inner portion of the vegetable composition;
applying an enzyme composition comprising water, at least one protease, at least one carbohydrase, at least one lipase, and a cellulase to the raw whole vegetable composition under normal atmospheric pressures for a time that is sufficient to form an enzyme-degraded raw vegetable composition, wherein the enzyme composition is at a pH of between about 2.0 and 6.0; and
deactivating the enzyme composition.

7. The method of claim 6 wherein the raw vegetable in said composition is a legume, a soybean, an edible seed, lentil, pulse, or any combination of any of these.

8. The method of claim 6 wherein the protease degrades a hydrophobic amino acid containing protein, a hydrophobic amino acid-containing peptide, or any combination of any of these.

9. The method of claim 6 wherein the at least one carbohydrase comprises alpha-galactosidase, alpha-amylase, hemicellulase, pectinase, or any combination of any of these.

10. The method of claim 6 wherein deactivating the enzyme composition includes freezing, drying, freeze-drying, canning, frying, hydrating, boiling, extruding, steaming, blanching, blending, cooking, baking, roasting, fermenting, peeling, pasteurizing, extracting, grilling, milling, puffing, micro-waving, enzymatic degradation, grinding, grating, pulverizing, steam-pressure cooking, or any combination of any of these.

11. The method of claim 6 wherein the enzyme composition is effective to degrade allergenic protein.

12. An enzyme-degraded vegetable composition comprising a raw whole vegetable composition in native form degraded by an enzyme composition comprising water, at least one carbohydrase, and at least one protease at an initial pH of about 2 to about 6.
